(19) United States
(12) Patent Application Publication
(10) Pub. No.: US 2012/0136869 A1
(43) Pub. Date: May 31, 2012

(54) System and Method of Processing Information Stored in Databases

(75) Inventors: Artur Kaufmann, Landau (DE); Tom Brauer, Speyer (DE); Sylvia Beate Stiefvater, Leimen (DE); Georg Lang, Ludwigshafen (DE); Beate Schwenk, Heidelberg (DE)

(73) Assignee: SAP AG, Walldorf (DE)

(21) Appl. No.: 12/956,364

(22) Filed: Nov. 30, 2010

(51) Int. Cl. G06F 17/30

(52) U.S. Cl. 707/741; 707/812; 707/E17.005; 707/E17.002

(57) ABSTRACT

In one embodiment the present invention includes a computer implemented method of processing information stored in a data structure. The method includes continuously generating individual records and storing the individual records in a database as a plurality of records. The method further includes selecting, according to a time period, a set of the plurality of records that qualify according to the time period. The method further includes moving the set to a table in the database, wherein the table excludes the plurality of records that are not in the set. In this manner, the records may be stored in a number of parallel tables, and this process may be managed at the application level instead of at the database level. Using parallel tables instead of a single large table may offer performance improvements, for example regarding deleting (or archiving) data.

### CROSS REFERENCE TO RELATED APPLICATIONS

Not applicable.

### BACKGROUND

The present invention relates to databases, and in particular, to processing information stored in databases.

Unless otherwise indicated herein, the approaches described in this section are not prior art to the claims in this application and are not admitted to be prior art by inclusion in this section.

In a data processing system, for example for processing invoices, records are being continuously generated, stored, and put onto invoices. Once an invoice has been paid, there may be little need to continue to store the underlying records, so they may be deleted from the database (or moved from the database into archival storage). The time and processing resources involved in deleting (or moving) the records may be extensive. Another common business requirement is to calculate the unbilled revenue for reporting purposes. In this process, the processing status of each single records is important. After the invoice has been created, it is also common to extract the invoice and each single record into an OLAP (online analytical processing) system. During extraction of invoices and records, the single records belonging to an invoice need to be selected efficiently. The standard way to store transactional data in a database is to use a single table.

### SUMMARY

Embodiments of the present invention improve the performance of processing information stored in databases. In particular, an example relating to the deletion of data is described. In one embodiment the present invention includes a computer implemented method of processing information stored in a data structure. The method includes continuously generating individual records and storing the individual records in a database as a plurality of records. The method further includes selecting, according to a time period, a set of the plurality of records that qualify according to the time period. The method further includes moving the set to a table in the database, wherein the table excludes the plurality of records that are not in the set. In this manner, the records may be stored in a number of parallel tables, and this process may be managed at the application level instead of at the database level. Using parallel tables instead of a single large table may offer performance improvements, for example regarding deleting (or archiving) data.

According to an embodiment, a computer system may be configured to perform the above process, for example by executing one or more computer programs. The computer system may include an application server and a database server.

According to an embodiment, a computer program, embodied on a non-transitory medium, may control a computer system to perform the above process.

According to an embodiment, computer implemented method processes information stored in a data structure. The method includes controlling, by an application server, a database server to configure a plurality of parallel tables in a database. The method further includes storing, by the application server, a plurality of rules. The method further includes receiving, by the application server, a transaction. The method further includes controlling, by the application server, the database server to store the transaction in an appropriate parallel table according to the plurality of rules.

The following detailed description and accompanying drawings provide a better understanding of the nature and advantages of the present invention.

### BRIEF DESCRIPTION OF THE DRAWINGS

FIG. 1 is a block diagram of a three tier architecture system that may be used to implement an embodiment of the present invention.

FIG. 2 is a diagram of a timeline that is used to illustrate the an embodiment of the present invention.

FIG. 3 is a flowchart of a process that illustrates parallel tables according to an embodiment of the present invention.

FIG. 4 is a block diagram of an example computer system and network for implementing embodiments of the present invention.

### DETAILED DESCRIPTION

Described herein are techniques for processing information stored in databases. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

In this document, various methods, processes and procedures are detailed. Although particular steps may be described in a certain order, such order is mainly for convenience and clarity. A particular step may be repeated more than once, may occur before or after other steps (even if those steps are otherwise described in another order), and may occur in parallel with other steps. A second step is required to follow a first step only when the first step must be completed before the second step is begun. Such a situation will be specifically pointed out when not clear from the context.

In this document, the terms “and”, “or” and “and/or” are used. Such terms are to be read as having the same meaning; that is, inclusively. For example, “A and B” may mean at least the following: “both A and B”, “only A”, “only B”, “at least both A and B”. As another example, “A or B” may mean at least the following: “only A”, “only B”, “both A and B”, “at least both A and B”. When an exclusive-or is intended, such will be specifically noted (e.g., “either A or B”, “at most one of A and B”).

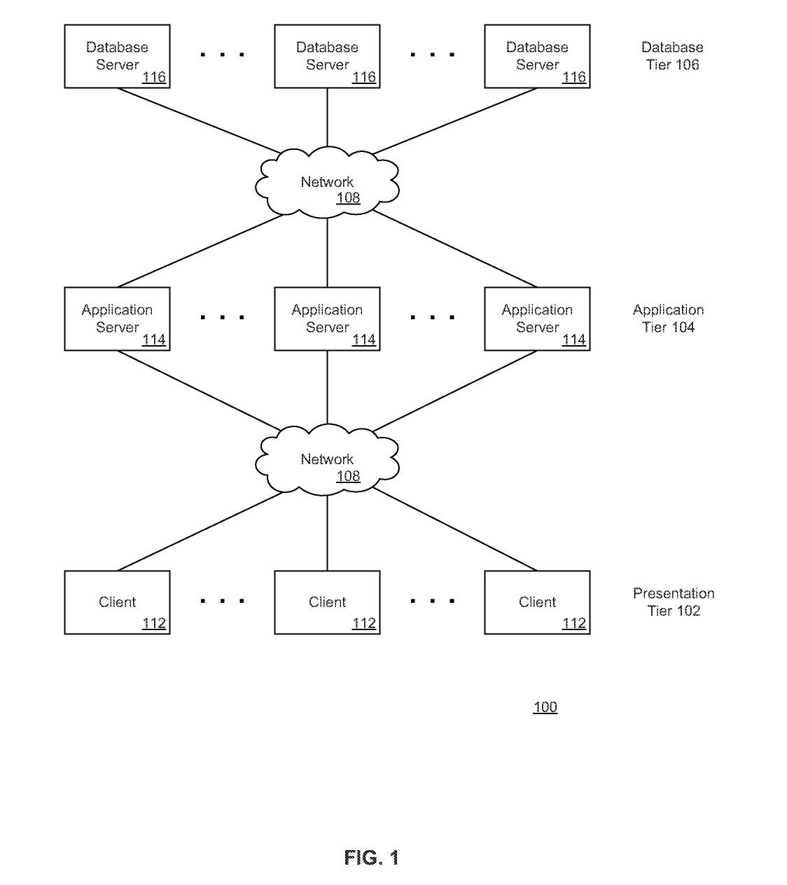

FIG. 1 is a block diagram of a three tier architecture system 100 that may be used to implement an embodiment of the present invention. The system 100 includes a presentation tier 102, an application tier 104, and a database tier 106. A network 108 connects the devices within and between the tiers. The network 108 may include one or more networks, such as a local area network, a wide area network, or the internet.

The presentation tier 102 generally includes one or more client computers 112. The client computers 112 generally provide a graphical user interface for users to interact with the other parts of the system 100. The user interface may be implemented by a browser, for example as a Java application.

The application tier 104 generally includes one or more application servers 114. The application servers 114 generally implement the business logic for processing interactions between the users and the underlying data. This business logic is generally referred to as “the application” or “the application program”. The application tier may implement various applications to perform various functions, such as invoicing, inventory control, supply chain management, etc. Various of the application servers 114 may perform different functions. For example, one of the application servers 114 may be used for prototyping or development, while the others may be used for business intelligence production activities.

The database tier 106 generally includes one or more database servers 116. The database servers 116 generally implement a database management system that stores and manipulates the underlying data and related metadata. This database management system is generally referred to as “the database” or “the database system” or “the database program”. The database servers 116 may implement various types of database systems, including DB2, Informix, MaxDB, Oracle and Microsoft SQL Server.

Although many separate devices are shown in each tier, such is mainly for illustration purposes to show scalability. For example, a single database server may be used in the basic configuration, but as the amount of data in the databases increases, the number of database servers 116 may be increased. As another example, a single application server may be used in the basic configuration, but as the amount of business logic processes increases, the number of application servers 114 may be increased.

The system 100 may be implemented in a variety of operating systems, for example, UNIX (AIX, HP-UX, Solaris, Linux), Microsoft Windows, IBM Series i (former iSeries, AS/400) and IBM zSeries (former S/390). The various devices in the various tiers may implement different operating systems. For example, a client computer 112 may run Microsoft Windows and an application server 114 may implement Linux. Note that various devices generally implement both an operating system program and another program, which are distinct. For example, a client computer 112 may implement Microsoft Windows (operating system) and Microsoft Internet Explorer (user interface program). An application server 114 may implement Linux (operating system) and an invoicing system (application program). A database server 116 may implement Linux (operating system) and Oracle database (database program).

The SAP Web Application Server is a specific example of an implementation of the system 100. An embodiment of the present invention generally involves an application program and a database program, as detailed below.

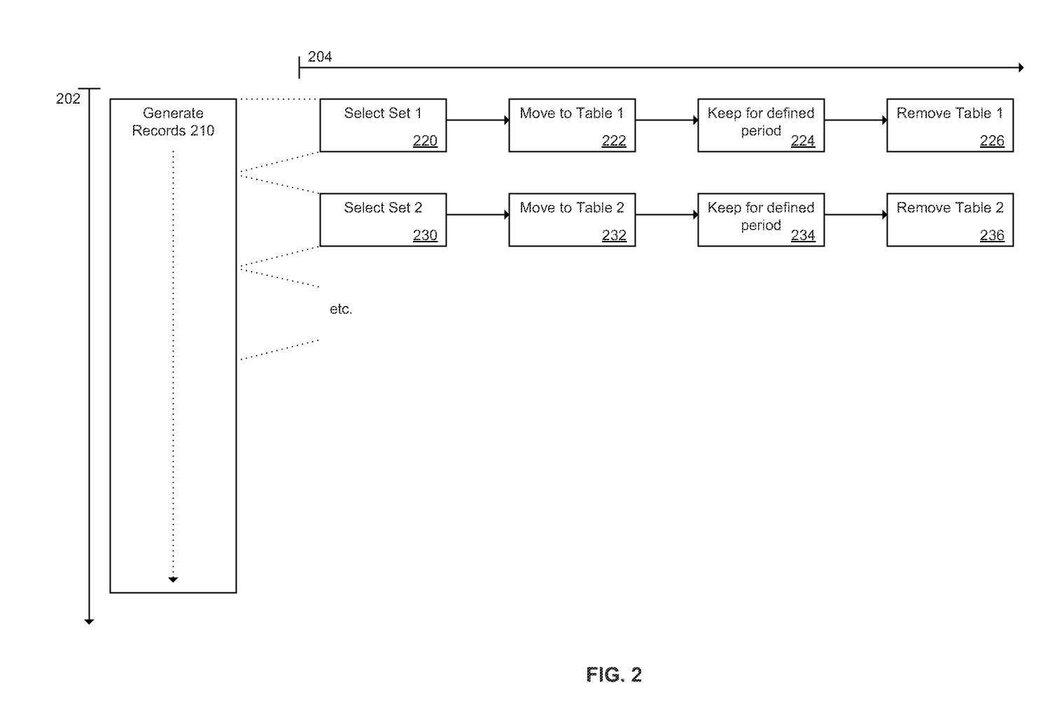

FIG. 2 is a diagram of a timeline 200 that is used to illustrate the an embodiment of the present invention. The timeline 200 includes a y axis 202 and an x axis 204. The y axis 202 shows the flow of a generally continuous data generation process where records 210 are generated. (The term “record” generally refers to a line item in a database that includes one or more pieces of data; a record may also be referred to as a “transaction”.) These records may be (for example) telephone call records, including information such as the calling number, the called number, the start time, the duration, the account number, the applicable tariff, the applicable tax, etc. These records are being continuously generated by the application program (see the application server 114 in FIG. 1 and related description). In the context of an embodiment of the present invention, “generated” also includes receiving records from other systems. For example, Company X may generate a record and send the record to Company Y, in which case Company Y generates a corresponding record in the records 210. The number of records in the records 210 may be very large, for example 1000000 customers each receive an invoice with 100 to 1000 calls every month, times the number of months retained in the records 210. The records 210 may be stored in a table in a database (see the database server 116 in FIG. 1 and related description).

The x axis 204 shows the flow of data processing according to an embodiment of the present invention. At 220, for a given time period, a set of the records are selected from the records 210. The time period may be, for example, a month; and the records selected are those that are to be invoiced for that month. The application program (see the application server 114 in FIG. 1 and related description) may select the set.

According to an embodiment, the set is selected as part of another process that may already be occurring as part of the data processing operations of the system 100 (see FIG. 1). For example, an invoicing process may already be occurring as one of the data processing operations. In such a case, the set selected for invoicing is also the set used in the additional processing described below.

At 222, the set selected in 220 is moved to a table in the database. In general, this table includes only the set selected in 220, and no others (e.g., the table excludes the records 210 that are not in the set). The application program (see the application server 114 in FIG. 1 and related description) may instruct the database program (see the database server 116 in FIG. 1 and related description) to move the set to the table in the database. The table may include other information related to the records in the set; for example, the set may be indexed according to the account number associated with each record.

At 224, the table (see 222) is stored for a defined duration. This duration may be set according to various factors. For example, there may be a legal requirement to store the records for a certain amount of time. There may be a contractual arrangement with the customers to store the records for a certain amount of time. The operator of the system 100 (see FIG. 1) may desire to delete records from the database, or to move records from the database to archival storage, after a certain amount of time. The operator of the system 100 (see FIG. 1) may desire to move or delete the records from the database after the associated invoices have been paid. The defined duration may then be selected to account for these time periods, or to account for other criteria.

At 226, the table (see 222) is removed from the database after the defined duration (see 224) has passed. The application program (see the application server 114 in FIG. 1 and related description) may instruct the database program (see the database server 116 in FIG. 1 and related description) to remove the table from the database. The table may be deleted, moved to archival storage, etc. If the database program itself includes functionality to move the table to archival storage, then the application program may instruct the database program to do so. Otherwise the application program may coordinate with other components of the system 100 (see FIG. 1) to move the table from the database to the archival storage. According to an embodiment, the SQL statement DROP TABLE may be used to remove the table.

According to an embodiment, the database program itself includes functionality to arrange the physical location of data depending upon a time stamp of the data record. (This functionality may also be referred to as logical table partitions.) In such an embodiment, the application program may instruct the database program to move the set (see 222 above) or to remove the table (see 226 above) using this functionality.

According to an embodiment, the database program does not include functionality to arrange the physical location of data depending upon a time stamp of the data record. In such an embodiment, the application program itself provides the set to the database program such that when the database program moves the set (see 222 above), the physical location of the data in the database is arranged according to the order provided by the application program; or when the database program removes the set (see 226 above), the application program instructs the database program to remove the set according to the order provided by the application program (which corresponds to the physical location of the data in the database).

As the records 210 continue to be generated, other sets may be selected, moved and removed in a similar manner to that described above (see 220, 222, 224 and 226), as further detailed below.

At 230, for another given time period, a second set of the records are selected from the records 210. In general, this time period immediately follows the preceding time period (see 220) without overlap. For example, if invoices are prepared monthly, then the first time period (see 220) may correspond to January and the second time period (see 230) may correspond to February. In such a case, there is no duplication of a record in the first set and the second set. According to another embodiment, the time periods (see 220 and 230) may overlap, in which case there may be duplication of records in the first set and the second set. According to another embodiment, there may be a gap between the first time period and the second time period, in which case some of the records 210 may not be selected for moving to a table.

At 232, the second set (selected in 230) is moved to a second table in the database. As with the first table (see 222), the second table in general excludes any of the records 210 that are not in the second set.

At 234, the second table (see 232) is stored for a defined duration. In general, this defined duration (in 234) has the same length as the first defined duration (in 224). However, the length could also differ. For example, the contractual arrangement with customers may be changed such that the duration is shortened (or lengthened).

At 236, the second table (see 232) is removed from the database after the defined duration (see 234) has passed.

In a similar manner, additional sets of data beyond the two shown and described may be selected, moved to tables, and the tables removed, as the records 210 continue to be generated. According to an embodiment, the records in the tables may be further arranged according to the account status (e.g., unbilled records, billed records, settled invoices, etc.). In general, these tables may be referred to as “parallel tables” in which the transactional data is divided amongst the tables in a “parallel” manner. Such an arrangement may be contrasted with existing transactional data processing systems that store the transactional data in a single table (e.g., the data is added to the single table for example in a “sequential” or “serial” manner).

As a result of the process shown in FIG. 2, removal of data from the database may be accomplished faster, as compared to a removal performed without moving the set to the table. More specifically, the selecting (see 220), the moving (see 222) and the removal (see 226) may be accomplished faster than a removal by itself. One way this benefit may be accomplished is that the set is already being processed (e.g., according to another data processing step such as invoicing), so the additional overhead of the selecting (see 220) and the moving (see 222) is low. Another way this benefit may be accomplished is that for the moving (see 222), the application program (or the database program) arranges the physical location data appropriately, as described above, so that the removal (see 226) may be accomplished faster than if the data had not been so arranged (or in other words, the physical location of the individual records in the set accounts for the planned future removal of the table from the database).

As an example, consider a transactional data system that receives 10 million transactions per month (120 million transactions in a year). The system operator desires to remove all transactions older than three months. In an existing system, the 120 million transactions are stored in a single table, so a deletion or archival process would have to analyze all 120 million entries to find the 90 million entries for deletion/archive. In contrast, in the system 100, the 120 million transactions may be stored in (for example) 12 parallel tables (1 for each month); the deletion/archival process may then proceed on a per-table basis, much quicker as compared to the existing system.

The following discussion provides more details of a specific implementation of an invoicing system that implements one or more of the data processing features that were described above. The invoicing system may be referred to as a convergent invoicing system, in that it generates a convergent bill where billing data from various sources is aggregated into a single invoice and is processed together. In general, the convergent invoicing system provides the interface to the account receivables system; handles account receivables charges, discounts and taxes; and supports bill data extraction and formatting for print. The convergent invoicing system may be part of another component, such as a contract accounts and receivable and payable (FI-CA) component, that may be part of a larger software system such as an enterprise resource planning financials program. The convergent invoicing system may include a billing subcomponent and an invoicing subcomponent.

The billing subcomponent processes transactions and additional data from other systems and creates structured bill content. Billing provides a billable item management feature that allows a user to transfer, store and monitor billable items and prepare them for billing execution. The billing process covers the handling of billable items for the purpose of creating, simulating and reversing billing documents.

The invoicing subcomponent allows a user to create convergent invoices. It merges billing information from a local billing system and billing systems from other providers into customer invoices. The invoicing process integrates the billing documents in the invoicing subcomponent. The invoicing subcomponent creates the invoice document that saves the information for the invoice and that is the base for the physical invoice printings and posts the invoice synchronously. Additionally the invoicing subcomponent may perform the following tasks: (1) Billing documents from different billing systems are selected, grouped, and displayed together on one invoice. (2) Billing documents are transferred to postings documents in the FI-CA component synchronously. The invoice display of the tax amounts can influence the tax to be posted. (3) Simultaneously, correspondence containers are created for invoice printing, and additional data is updated for providing data to a business intelligence system. (4) Current information for the customer account, such as open invoice receivables, can be displayed on the invoice. Further FI-CA business transactions can be integrated in the invoicing processes such that the customer can be informed of changes to the customer account with the invoice. For example, in an invoicing run, a contract account maintenance can be processed by the run. The invoicing run can clear open items of an invoice with credit memo items of a contract account.

In general, invoicing orders must exist in order for an invoicing process to be started. These are created when a billing document is created and are used for specific selection of the billing documents not yet processed by an invoicing process. If the invoicing of a billing document is successful, the related invoicing order is deleted.

In addition to billing documents that arise in the local system from the transfer of billing documents from external systems, sales and distribution (SD) billing documents from the SD component and collective bills from the FI-CA component can also be understood as invoiceable billing documents. Special invoicing processes can process these source documents, provided there are invoicing orders of the corresponding source document category.

Parallel processing of the dataset is generally possible. The invoicing processes use the function of the mass activity in FI-CA to split the dataset and distribute processing to different processes in order to reduce the processing time. Parallel processing may also be performed during part or all of the process described in FIG. 2.

The Contract Accounts Receivable and Payable component is a subledger developed for industries with a large number of business partners and a correspondingly high volume of documents to post, such as telecommunications companies. This component provides standard accounts receivable and accounts payable functions including dunning, posting documents, and making payments.

The business processes and functions of the FI-CA component may be integrated with a customer relationship management client, such as the CRM Interaction Center Web Client by means of a financial customer care component. Example CRM functions include the following: (1) Financial Customer Care: This scenario offers basic functions, such as an account overview, the display of the dunning history, and the search for payments of a customer. (2) Collections Management: This scenario covers important processes, such as the initiation of customer calls, processing of payments, and the granting of deferrals and installment plans.

Additional Features and Terminology

The system 100 may implement various entities, including items, components and processes. Some specific examples are described below.

A billable item is created by a business transactions or business events and is an item that is to be billed. A billable item can have different statuses at different points in time. In billing, the system considers only those billable items that have the status “billable”. Once these items are successfully processed during billing, the system sets the status to “billed” for them. The various statuses of billable items may be reflected on a technical level using different database tables. According to an embodiment, there is one database table for each combination of status and billable item class. One exception to this rule is the status “billed”. For this status, the user can specify how many tables are used, and how they are to be used. As an example, the system 100 allows the system operator to configure up to 100 parallel tables for transactional use.

The upload rule specifies that the system does one of the following with billable items during the transfer: (1) Adds them directly to the table of billable items. (2) Adds them to the table for raw data. (3) Returns them as having errors.

In relation to the database tables used, the system may differentiate based on the following record types: (1) Main items, which represent the actual receivable or payable. (2) Record types dependent on main items, which represent attachments to the main items (for example, credit card payments or taxation information). The main items and the dependent record types may use separate database tables.

The billable item class determines the following technical attributes of a billable item: (1) Database tables in which the system saves the billable items, dependent on their status and on the record type they belong to. (2) Function modules that receive the billable items. (3) Function modules that save the billable items to the appropriate database tables. (4) Specific fields of billable items that are added either by customer selection of interface components or using customer fields. For each billable item class, customer-specific checks and data enrichment can be added at various events.

The interface component represents a business process from the viewpoint of billing. The interface component defines which business transactions a billable item class supports (such as, deferred revenues and down payment clearings). Interface components are therefore the interface of a billable item class. From a technical perspective, an interface component consists of the documentation of the component, the selection of needed fields, and the specification of dependent/prerequisite interface components, along with checks, derivations, and assignments of field values.

A source transaction is defined by the combination of a source transaction type and source transaction ID. A source transaction represents a group of billable items that belong together from a business viewpoint. According to an embodiment, further processing of billable items may be controlled by the source transaction, that is, by each combination of a source transaction ID and source transaction type. A source transaction can include billable items belonging to different record type.

The billable item type, together with the subprocess, specifies the business significance of an individual billable item. Each item type is assigned to one or more subprocesses.

A subprocess is a self-sufficient processing branch within a billing process for the selection and grouping of billable items and forming a billing document. According to an embodiment, billable items are immediately assigned to a subprocess when they are created. In such an embodiment, it is not desirable for the system to process them together with billable items of another subprocess in a common billing document.

The billing process is the superordinate term for the execution of billing according to defined rules. These rules are defined by parameters used to control the billing process. The billing process specifies which subprocesses it supports. For each subprocess the billing process specifies: (1) Which contract accounts are billed. (2) Which billable items are selected for billing. (3) How the billable items are grouped into billing units and, as a consequence, how they are grouped into billing documents.

The selection variant specifies which billable item class the billable items are selected from, and therefore also which billable items are processed in the billing process.

The grouping variant is used for storing the rules for automatic grouping of billable items for processing during billing. The grouping variant determines which billable items are grouped together in one billing unit and controls the link between the billable items and the items of the billing document.

An invoicing process is the superordinate term for the execution of invoicing functions according to defined rules. The invoice process controls: (1) Selection of the source documents to be invoiced. (2) Summary of source documents to invoicing units. (3) Selection of invoicing functions.

Deleting Billed Items

As discussed above, the system 100 may delete billed items from the database for various reasons (legal, contractual, to reduce the load, to improve performance, etc.). In general, to delete billed items, three criteria should be met. First, all the billed items of a table set are invoiced (e.g., as part of the selection discussed above at 220). Second, the billed items have reached the designated residence time (e.g., the defined period discussed above at 224). The defined period may be set globally for all the tables (of the billed items) in the database, or particular tables may have individually-defined retention periods. Third, the system 100 is not currently using the table set for storing billed items (e.g., the table set is not being used for archival storage).

According to an embodiment, the system 100 uses the date of the latest entry for a table set to check the residence time. For example, if the latest record in the first table (see 222 above) is dated 31 Jan. 2010, the system 100 uses that date when checking the residence time.

According to an embodiment, the system 100 stores the billed items for each billable item class in a separate table and groups these into table sets. According to an embodiment, the system 100 sequentially numbers the table sets that exist for a billable item class. At runtime, the billing process determines the table set to be used for storing billed items. For example, the system 100 may be configured with three parallel tables, one each for January, February and March. When a transaction is received with a particular transaction date, the system 100 routes that transaction to the appropriate table. When the system 100 performs the billing process for a particular month, the system 100 accesses the appropriate parallel table for that month. Additional parallel tables, or more complex logic to route transactions to the appropriate parallel table, may be used as desired.

Billing Process

As discussed above, the system 100 may select and move the records to the tables (see 220 and 222 above) as part of other data processing operations. One such data processing operation is the billing process. In general, billing takes place in four individual process steps: data selection, creation of billing units, aggregation of billable items, and updating.

During data selection, the system 100 selects the billable items for the billing process. For example, this selection may also be used as the selection described above at 220. The user may define the selection criteria for the data selection in selection variants for the billing process.

During the creation of billing units, the system 100 groups together the selected billable items into billing units for each contract account. Multiple billing units can be created for each contract account. Billing in Contract Accounts Receivable and Payable creates one billing document for each billing unit. The user may define the criteria that are used to create the billing units in grouping variants for the billing process.

During the aggregation of billable items, the system 100 includes the selected billable items of a billing unit in the billing document. More exactly, the billable items are summarized in billing document items. The individual items that belong to this summarization are linked with the billing document item.

During updating, the system 100 writes the billing document created for the billing unit and the individual billed items to the database, and at the same time deletes the processed billable items.

Although the examples described above have used an invoicing system for discussion purposes, various other types of data processing systems may benefit from having one or more features of an embodiment of the present invention. For example, similar features may be used to improve the performance of a music storage system, for example an MP3 store.

Although the example described above has related to deleting or archiving data, the principles of embodiments of the present invention may be used for other data processing activities. One such activity is to calculate the unbilled revenue. More specifically, the billed records may be stored in one table, and the billable records may be stored in another. To calculate the unbilled revenue, a simple aggregate function may be executed on the table of billable records. (This may be contrasted with a system that stores both billed and billable records in a single table, in which a more complex analysis regarding the billing status must be performed to determine whether each particular record should be added when calculating the unbilled revenue.)

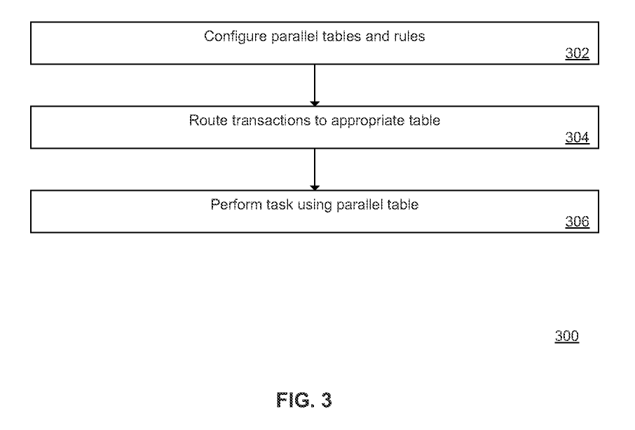

FIG. 3 is a flowchart of a process 300 that illustrates parallel tables according to an embodiment of the present invention. The process 300 may be implemented by the system 100, for example by one or more computer programs that are stored by or executed by hardware components of the system 100.

At 302, the user configures the system by setting up parallel tables in the database and by configuring rules to arrange transactions in the appropriate parallel table. For example, in the system 100 (see FIG. 1), the user may use an application program executing on the application server 114, that interfaces with the database server 116, to set up the parallel tables in the database stored by the database server 116. The user may also use the application program to configure the rules, so that when transactions arrive at the application server 114, the application server 114 routes them to the appropriate parallel table in the database. Note that this process is performed at the application tier 104; the database tier 106 is thus not required to itself perform partitioning of transactions. Similarly, the application administrator (e.g., the system administrator of the application tier 104) configures the system 100 to perform this process, instead of the database administrator (e.g., the system administrator of the database tier 106).

Thus, the application administrator may use application-level information about the business process, the transactions, etc. in order to appropriately configure the parallel tables and the rules. (This may be contrasted with existing systems that operate at the database-level, and thus may lack information about the overall business process and the resulting flow of transactions therein.) For example, the application administrator may know that invoices are to be processed monthly according to a given business process, in which case 12 parallel tables may be configured, and the rules route each transaction to its appropriate parallel table based on the month. As another example, the application administrator may know that a particular month has a high number of transactions, and so 13 parallel tables may be configured (11 for the 11 average months, and 2 for the 1 heavy month). Note that each of these examples would be difficult (or impossible) to implement at the database-level; in contrast, the system 100 may implement two or more of these examples concurrently.

At 304, transactions arrive and are routed to the appropriate parallel table. For example, in the system 100 (see FIG. 1), the application server 114 receives a transaction (e.g., a telephone call record as discussed above), accesses the rules (see 302), and indicates to the database server 116 the appropriate parallel table in the database to store the transaction. As discussed above, the evaluation of the rules and the routing occurs at the application level, not at the database level.

At 306, a task is performed that accesses one or more of the parallel tables. The task can be part of a business process such as deleting (or archiving) as discussed above with reference to FIG. 2, calculating unbilled revenue, etc. As detailed above, using parallel tables may be more efficient than using a single table. For example, instructing the database server 116 to delete one of the parallel tables (e.g., billed records in January) may be more efficient than instructing the database server 116 to select records from a single table that were billed in January, then to delete those records.

Note that the processes of FIG. 2 and FIG. 3 may be viewed as variations on the same process. In FIG. 2, the process illustrates that the rules may be configured to route batches of transactions, whereas in FIG. 3, the process illustrates that the rules may be configured to route each transaction individually. For example, an invoicing process may be performed monthly; the steps 302 and 304 together may then be viewed as implementing part of the process described above in FIG. 2. More specifically, as each of the records 210 is generated, the record is selected (see 220) according to the rules (see 302) and routed to the appropriate parallel table (see 222 and 304).

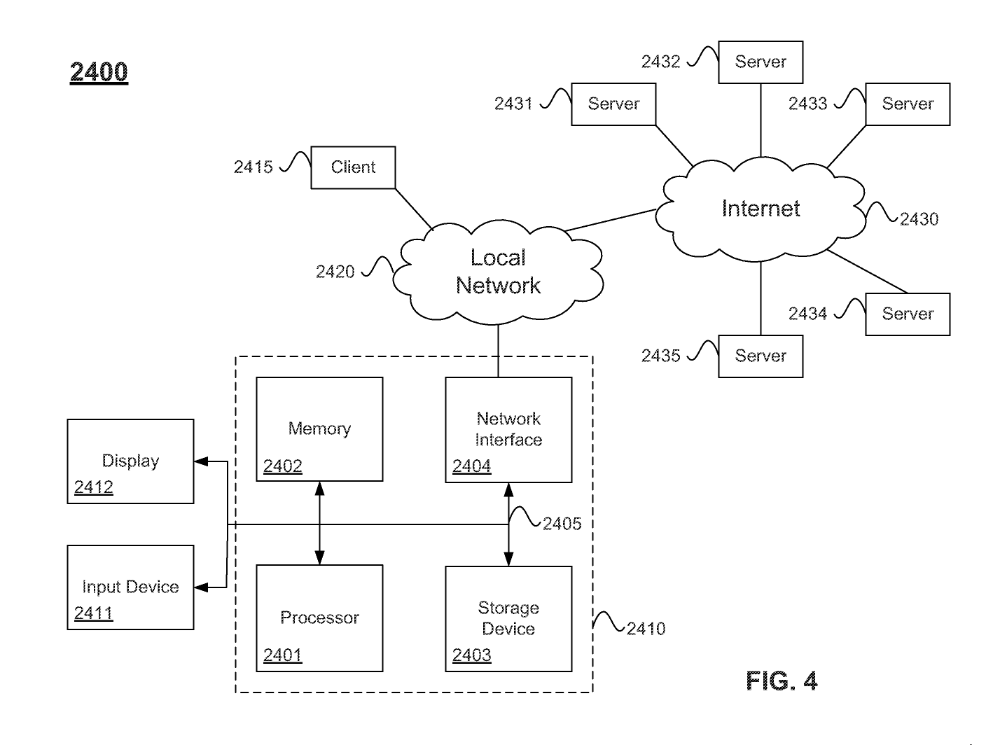

FIG. 4 is a block diagram of an example computer system and network 2400 for implementing embodiments of the present invention. Computer system 2410 includes a bus 2405 or other communication mechanism for communicating information, and a processor 2401 coupled with bus 2405 for processing information. Computer system 2410 also includes a memory 2402 coupled to bus 2405 for storing information and instructions to be executed by processor 2401, including information and instructions for performing the techniques described above. This memory may also be used for storing temporary variables or other intermediate information during execution of instructions to be executed by processor 2401. Possible implementations of this memory may be, but are not limited to, random access memory (RAM), read only memory (ROM), or both. A storage device 2403 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 2403 may include source code, binary code, or software files for performing the techniques or embodying the constructs above, for example.

Computer system 2410 may be coupled via bus 2405 to a display 2412, such as a cathode ray tube (CRT) or liquid crystal display (LCD), for displaying information to a computer user. An input device 2411 such as a keyboard and/or mouse is coupled to bus 2405 for communicating information and command selections from the user to processor 2401. The combination of these components allows the user to communicate with the system. In some systems, bus 2405 may be divided into multiple specialized buses.

Computer system 2410 also includes a network interface 2404 coupled with bus 2405. Network interface 2404 may provide two-way data communication between computer system 2410 and the local network 2420. The network interface 2404 may be a digital subscriber line (DSL) or a modem to provide data communication connection over a telephone line, for example. Another example of the network interface is a local area network (LAN) card to provide a data communication connection to a compatible LAN. Wireless links is also another example. In any such implementation, network interface 2404 sends and receives electrical, electromagnetic, or optical signals that carry digital data streams representing various types of information.

Computer system 2410 can send and receive information, including messages or other interface actions, through the network interface 2404 to an Intranet or the Internet 2430. In the Internet example, software components or services may reside on multiple different computer systems 2410 or servers 2431, 2432, 2433, 2434 and 2435 across the network. A server 2431 may transmit actions or messages from one component, through Internet 2430, local network 2420, and network interface 2404 to a component on computer system 2410.

The computer system and network 2400 may be configured in a client server manner. For example, the computer system 2410 may implement a server. The client 2415 may include components similar to those of the computer system 2410.

More specifically, the client 2415 may implement a client-side interface for displaying information generated by the server, for example via HTML or HTTP data exchanges. The computer system 2410 may implement the system 100 as part of implementing an application server, for example by executing one or more computer programs. The processor 2401 may implement the functionality of the application as it performs the data processing steps described in FIG. 2. The client 2415 may implement a graphical user interface for interacting with the system 100. The server 2431 may implement a database server that manages the database used during the data processing steps described in FIG. 2.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer implemented method of processing information stored in a data structure, comprising:
continuously generating individual records;
storing the individual records in a database as a plurality of records;
selecting, according to a time period, a set of the plurality of records that qualify according to the time period; and
moving the set to a table in the database, wherein the table excludes the plurality of records that are not in the set.

2. The method of claim 1, wherein moving the set to the table comprises moving the set to the table such that a physical location of the individual records in the set accounts for a planned future removal of the table from the database.

3. The method of claim 1, further comprising:
indexing the set in the table according to a plurality of accounts that are associated with the plurality of records.

4. The method of claim 1, wherein the time period comprises a first time period, wherein the set comprises a first set, and wherein the table comprises a first table, further comprising:
selecting, according to a second time period, a second set of the plurality of records that qualify according to the second time period, wherein the second set differs from the first set according to a difference between the first time period and the second time period; and
moving the second set to a second table in the database, wherein the second table excludes the plurality of records that are not in the second set.

5. The method of claim 1, further comprising:
storing the table in the database for a defined duration.

6. The method of claim 1, further comprising:
removing the table from the database after a defined duration has passed.

7. The method of claim 1, further comprising:
removing the table from the database after a defined duration has passed,
wherein the selecting act, the moving act and the removing act when taken together result in a faster removal of the set from the database as compared to deleting the set.

8. The method of claim 1, wherein the computer implemented method is implemented by an application server and a database server, wherein the database server is configured to store the individual records in the database, and wherein the application server is configured to instruct the database server to move the set to the table.

9. A system for controlling a computer system to process information stored in a data structure, comprising:
an application server computer that is configured to continuously generate individual records; and
a database server computer that is configured to store the individual records in a database as a plurality of records,
wherein the application server is configured to select, according to a time period, a set of the plurality of records that qualify according to the time period, and
wherein the application server is configured to instruct the database server to move the set to a table in the database, wherein the table excludes the plurality of records that are not in the set.

10. The system of claim 9, further comprising:
a client computer that is configured to provide the individual records to the application server computer.

11. A computer implemented method of processing information stored in a data structure, comprising:
controlling, by an application server, a database server to configure a plurality of parallel tables in a database;
storing, by the application server, a plurality of rules;
receiving, by the application server, a transaction; and
controlling, by the application server, the database server to store the transaction in an appropriate parallel table according to the plurality of rules.

12. The method of claim 11, further comprising:
performing, by the application server, a business process that accesses one of the plurality of parallel tables.

13. The method of claim 11, further comprising:
performing, by the application server, a business process that accesses one of the plurality of parallel tables, wherein the accessing is more efficient than when using a single table.

14. The method of claim 11, further comprising:
deleting one of the plurality of parallel tables, wherein the deleting is more efficient than when using a single table.

15. The method of claim 11, further comprising:
storing one of the plurality of parallel tables for a defined duration; and
removing the one of the plurality of parallel tables from the database after the defined duration has passed.

16. The method of claim 11, wherein the transaction comprises a first transaction, and wherein the appropriate parallel table comprises a first appropriate parallel table, further comprising:
receiving, by the application server, a second transaction; and
controlling, by the application server, the database server to store the second transaction in a second appropriate parallel table according to the plurality of rules, wherein the first appropriate parallel table differs from the second appropriate parallel table.
